(19) United States
(12) Patent Application Publication
(10) Pub. No.: US 2026/0079869 A1
(43) Pub. Date: Mar. 19, 2026

(54) COMMUNICATION METHOD, CONTROLLER, AND CHIP

(71) Applicant: Kioxia Corporation, Tokyo (JP)

(72) Inventor: Akihiro FUKUSHIMA, Yokohama Kanagawa (JP)

(73) Assignee: Kioxia Corporation, Tokyo (JP)

(21) Appl. No.: 19/075,956

(22) Filed: Mar. 11, 2025

(30) Foreign Application Priority Data
Sep. 18, 2024 (JP) 2024-161063

(51) Int. Cl. G06F 13/36

(52) U.S. Cl. CPC G06F 13/36; G06F 2213/40

(57) ABSTRACT

According to one embodiment, a communication method is provided. The communication method includes transmitting a first packet including identification information on a first chip and designation of a first size from a controller to a first bus. The communication method includes enabling first data of the first size to be transferred from the first chip to a second bus in response to the first packet being received by the first chip. The communication method includes releasing the second bus after the transfer of the first data is completed.

### CROSS-REFERENCE TO RELATED APPLICATIONS

This application is based upon and claims the benefit of Japanese Patent Application No. 2024-161063, filed on Sep. 18, 2024; the entire contents of which are incorporated herein by reference.

### FIELD

Embodiments described herein relate generally to a communication method, a controller, and a chip.

### BACKGROUND

In a system where multiple chips are connected to a controller, on receipt of packets from the controller to the chips, data transfer is performed from the chips to a data bus. At this time, it is desirable that the data transfer be performed efficiently.

### BRIEF DESCRIPTION OF THE DRAWINGS

FIG. 1 is a diagram illustrating a schematic configuration of a memory system to which a communication method according to a first embodiment is applied;

FIG. 2 is a diagram illustrating the configuration of the memory system in the first embodiment;

FIGS. 3A and 3B are diagrams illustrating the communication method according to the first embodiment;

FIGS. 4A and 4B are diagrams illustrating the communication method according to the first embodiment;

FIG. 5 is a diagram illustrating the schematic configuration of the memory system in a modification of the first embodiment;

FIG. 6 is a diagram illustrating the configuration of the memory system in the modification of the first embodiment;

FIGS. 7A and 7B are diagrams illustrating a communication method according to a second embodiment;

FIGS. 8A and 8B are diagrams illustrating a communication method according to a third embodiment;

FIGS. 9A and 9B are diagrams illustrating the communication method according to the third embodiment;

FIGS. 10A and 10B are diagrams illustrating a communication method according to a fourth embodiment;

FIGS. 11A to 11C are diagrams illustrating a communication method according to a fifth embodiment;

FIGS. 12A to 12C are diagrams illustrating a communication method according to a sixth embodiment;

FIGS. 13A and 13B are diagrams illustrating a communication method according to a seventh embodiment;

FIGS. 14A and 14B are diagrams illustrating the communication method according to the seventh embodiment;

FIG. 15 is a diagram illustrating a configuration of a memory system according to an eighth embodiment;

FIGS. 16A and 16B are diagrams illustrating the communication method according to the eighth embodiment;

FIGS. 17A and 17B are diagrams illustrating the communication method according to the eighth embodiment; and

FIG. 18 is a diagram illustrating a configuration of a memory system according to a modification of the eighth embodiment.

### DETAILED DESCRIPTION

In general, according to one embodiment, there is provided a communication method. The communication method includes transmitting a first packet from a controller to a first bus, the first packet including identification information on a first chip and designation of a first size. The communication method includes enabling first data of the first size to be transferred from the first chip to a second bus in response to the first packet being received by the first chip. The communication method includes releasing the second bus after the transfer of the first data is completed.

Exemplary embodiments of a communication method will be explained below in detail with reference to the accompanying drawings. The present invention is not limited to the following embodiments.

### First Embodiment

A communication method according to the first embodiment is used to access one or more chips of multiple chips from a controller in a memory system, and measures are taken to efficiently access the chips.

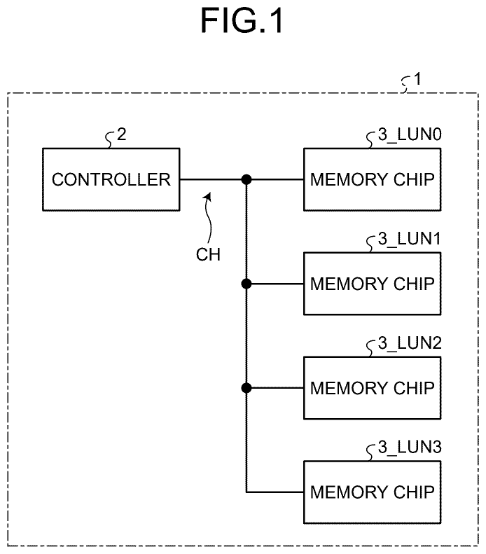

The communication method may be applied to a memory system 1 as illustrated in FIG. 1. FIG. 1 is a diagram illustrating a schematic configuration of the memory system 1 to which the communication method is applied.

The memory system 1 includes a controller 2, memory chips 3_LUN0, 3_LUN1, 3_LUN2, and 3_LUN3. The controller 2 and the multiple memory chips 3_LUN0 to 3_LUN3 are connected via a channel CH to allow communication with each other. The controller 2 and the multiple memory chips 3_LUN0 to 3_LUN3 may communicate according to the SCA Protocol.

The channel CH is constructed based on a predetermined standard. If each memory chip 3 is a NAND flash memory, the predetermined standard is, for example, the toggle DDR standard. The predetermined standard may support the SCA protocol in the toggle DDR standard.

The channel CH includes multiple signal lines. The channel CH may include a command address bus CA_bus, a clock line CA_CLK, a data bus DQ_bus, a read enable line RE⁻/RE, and a data strobe signal DQS⁻/DQS.

The command address bus CA_bus is used to transmit packets including commands and addresses. The clock line CA_CLK is used to transmit a clock to capture packets. The data bus DQ_bus is used to transmit data.

The read enable line RE⁻/RE is used to transmit a read enable signal RE⁻/RE, which is a signal for timing to capture data. The read enable signal RE⁻/RE is a pair of differential signals.

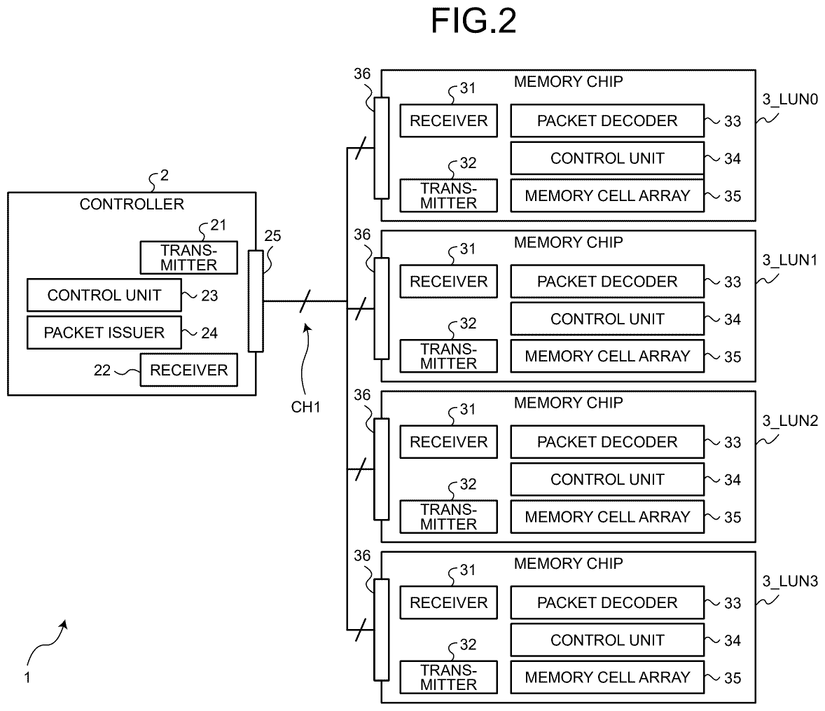

In the memory system 1, the controller 2 includes a transmitter 21, a receiver 22, a control unit 23, a packet issuer 24, and a channel interface 25 as illustrated in FIG. 2. FIG. 2 is a diagram illustrating a configuration of the memory system 1. Each memory chip 3 includes a receiver 31, a transmitter 32, a packet decoder 33, a control unit 34, a memory cell array 35, and a channel interface 36.

The channel interface 25 of the controller 2 is connected to the channel CH. The channel interface 25 performs interface operations for the channel CH.

The packet issuer 24 issues a packet PK1 including identification information on the memory chip 3 and size designation. The packet issuer 24 may issue a “Pre-defined Trans Num” packet as the packet PK1. The “Pre-defined Trans Num” packet is a packet that is not in the SCA protocol, but may be newly defined and be preset in the packet issuer 24.

The “Pre-defined Trans Num” packet can be issued to transfer data of the size designated by the size designation at a recipient and then to release the data bus DQ_bus. After being issued once, this packet will continue to be applied at the recipient. The “Pre-defined Trans Num” packet can also be issued to finish this continued application at the recipient by including designation of a zero size.

The packet issuer 24 may issue a select chip enable (SCE) packet including the identification information on the memory chip 3 and an instruction to start transfer. The SCE packet is defined in the SCA Protocol.

When the packet PK1 is issued by the packet issuer 24, the control unit 23 waits until timing to transmit the packet PK1. When the timing to transmit the packet PK1 arrives, the control unit 23 supplies the packet PK1 to the transmitter 21.

The transmitter 21 transmits the packet PK1 to the command address bus CA_bus. This allows the controller 2 to notify the memory chip 3 of the size (for example, transfer byte count) in advance.

The channel interface 36 of the memory chip 3 is connected to the channel CH. The channel interface 36 performs interface operations for the channel CH.

The receiver 31 checks the identification information on the memory chip 3 included in the packet PK1. When the identification information on the memory chip 3 included in the packet PK1 matches identification information on the memory chip 3 itself, the receiver 31 receives the packet PK1 via the command address bus CA_bus.

The control unit 34 waits until the packet PK1 is received, and when the packet PK1 is received by the receiver 31, the control unit 34 passes the packet PK1 to the packet decoder 33.

The packet decoder 33 decodes the packet PK1 and extracts the size designation from the packet PK1. The packet decoder 33 may decode the “Pre-defined Trans Num” packet and extract the size designation from the “Pre-defined Trans Num” packet. The “Pre-defined Trans Num” packet is a packet that is not in the SCA protocol, but may be newly defined and preset in the packet decoder 33. The packet decoder 33 passes the size designation as a decoding result to the control unit 34.

The control unit 34 reads data DT of the designated size from the memory cell array 35, passes the read data to the transmitter 32, and notifies the transmitter 32 of the size designation.

The transmitter 32 transmits the data DT of the designated size to the data bus DQ_bus.

The receiver 22 receives the data DT via the data bus DQ_bus.

After the transmission of the data DT of the designated size is completed, the transmitter 32 releases the data bus DQ_bus.

That is, when the transfer of a predetermined number of transfers is completed, the memory chip 3 automatically releases the data bus DQ_bus. This eliminates the need to issue a select chip terminate (SCT) packet recommended as a transfer completion notification in the SCA protocol, thereby being able to suppress degradation of transfer performance due to SCT issuance time.

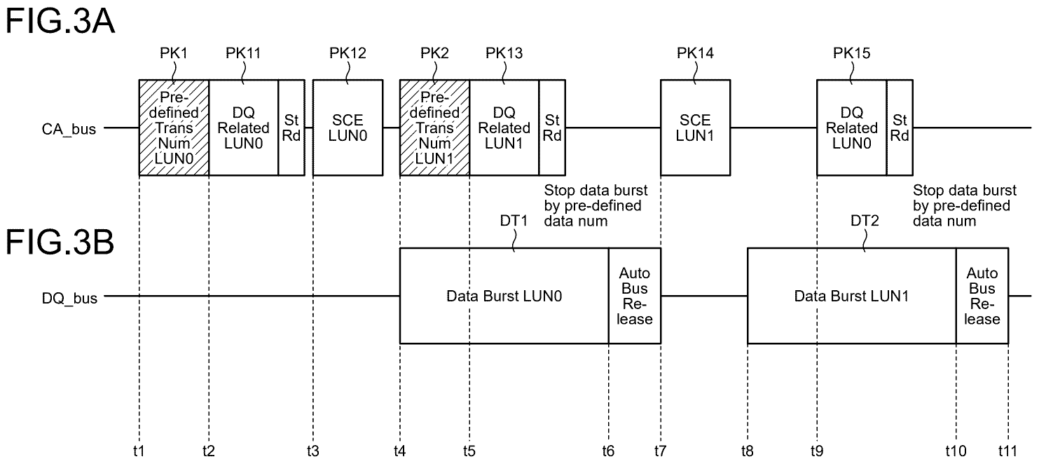

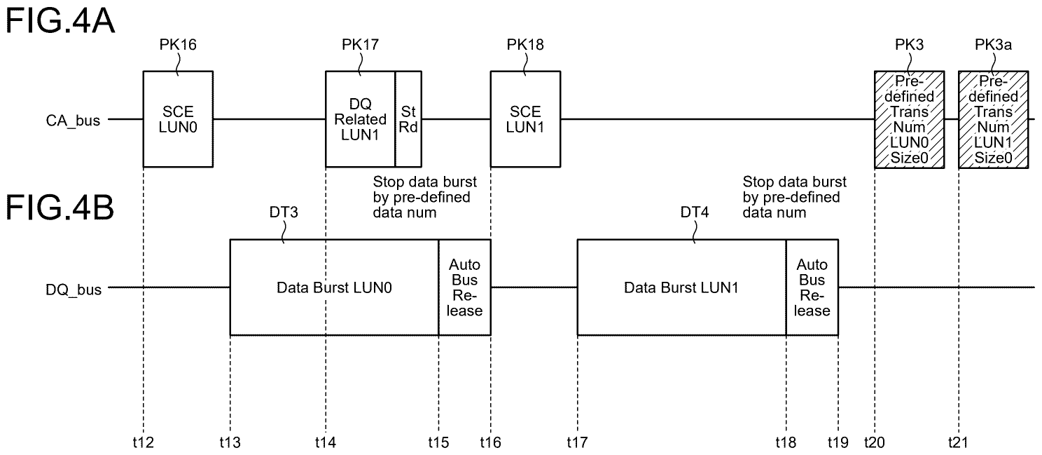

Next, the communication method will be described with reference to FIGS. 3A, 3B, 4A, and 4B. FIGS. 3A, 3B, 4A, and 4B are diagrams each illustrating the communication method. In FIGS. 3A, 3B, 4A, and 4B, the horizontal axis is time. FIGS. 3A and 4A each illustrate the sequence of packets transferred via the command address bus CA_bus.

FIGS. 3B and 4B each illustrate the sequence of data transferred via the data bus DQ_bus.

At timing t1, a “Pre-defined Trans Num LUN0” packet PK1 including the identification information “LUN0” on the memory chip 3_LUN0 and the designation of a size DS1 is transmitted from the controller 2 to the command address bus CA_bus. Afterward, the “Pre-defined Trans Num LUN0” packet PK1 is received by the memory chip 3_LUN0.

At timing t2, a “DQ Related LUN0” packet PK11 including the identification information “LUN0” on the memory chip 3_LUN0 and a transfer instruction is transmitted from the controller 2 to the command address bus CA_bus. Afterward, the “DQ Related LUN0” packet PK11 is received by the memory chip 3_LUN0. Note that the “DQ Related LUN0” packet is defined in the SCA protocol as a general term for data transfer commands using the DQ Bus.

At timing t3, an SCE packet PK12 including the identification information “LUN0” on the memory chip 3_LUN0 and the instruction to start transfer is transmitted from the controller 2 to the command address bus CA_bus. Afterward, the SCE packet PK12 is received by the memory chip 3_LUN0.

At timing t4, data DT1 of the size DS1 designated in the packet PK1 starts to be transmitted from the memory chip 3_LUN0 to the data bus DQ_bus.

In parallel with this, a “Pre-defined Trans Num LUN1” packet PK2 including identification information “LUN1” on the memory chip 3_LUN1 and the designation of size DS2 is transmitted from the controller 2 to the command address bus CA_bus. Afterward, the “Pre-defined Trans Num LUN1” packet PK2 is received by the memory chip 3_LUN1.

At timing t5, a “DQ Related LUN1” packet PK13 including the identification information “LUN1” on the memory chip 3_LUN1 and the transfer instruction is transmitted from the controller 2 to the command address bus CA_bus. Afterward, the “DQ Related LUN1” packet PK13 is received by the memory chip 3_LUN1.

At timing t6, the size of the data DT1 reaches DS1, and the transmission of the data DT1 from the memory chip 3_LUN0 to the command address bus CA_bus is completed.

At timing t7, the data bus DQ_bus is released by the memory chip 3_LUN0 upon completion of transmission of the data DT1. This allows other memory chips 3_LUN 1 to 3_LUN3 to use the data bus DQ_bus.

In response, an SCE packet PK14 including the identification information “LUN1” on the memory chip 3_LUN1 and the instruction to start transfer is transmitted from the controller 2 to the command address bus CA_bus. Afterward, the SCE packet PK14 is received by the memory chip 3_LUN1.

At timing t8, data DT2 of the size DS2 designated in the packet PK2 starts to be transmitted from the memory chip 3_LUN1 to the data bus DQ_bus.

At timing t9, a “DQ Related LUN0” packet PK15 including the identification information “LUN0” on the memory chip 3_LUN0 and the transfer instruction is transmitted from the controller 2 to the command address bus CA_bus. Afterward, the “DQ Related LUN0” packet PK15 is received by the memory chip 3_LUN0.

At timing t10, the size of the data DT2 reaches DS2, and the transmission of the data DT2 from the memory chip 3_LUN1 to the data bus DQ_bus is completed.

At timing t11, the data bus DQ_bus is released by the memory chip 3_LUN1 upon completion of the transmission of the data DT2. This allows other memory chips 3_LUN0, 3_LUN2, and 3_LUN3 to use the data bus DQ_bus.

At timing t12, an SCE packet PK16 including the identification information “LUN0” on the memory chip 3_LUN0 and the instruction to start transfer is transmitted from the controller 2 to the command address bus CA_bus. Afterward, the SCE packet PK16 is received by the memory chip 3_LUN0.

At timing t13, data DT3 of the size DS1 designated in the packet PK1 starts to be transmitted from the memory chip 3_LUN0 to the data bus DQ_bus.

At timing t14, a “DQ Related LUN1” packet PK17 including the identification information “LUN1” on the memory chip 3_LUN1 and the transfer instruction is transmitted from the controller 2 to the command address bus CA_bus. Afterward, the “DQ Related LUN0” packet PK17 is received by the memory chip 3_LUN1.

At timing t15, the size of the data DT3 reaches DS1, and the transmission of the data DT3 from the memory chip 3_LUN0 to the command address bus CA_bus is completed.

At timing t16, the data bus DQ_bus is released by the memory chip 3_LUN0 upon completion of the transmission of the data DT3. This allows other memory chips 3_LUN1 to 3_LUN3 to use the data bus DQ_bus.

In response, an SCE packet PK18 including the identification information “LUN1” on the memory chip 3_LUN1 and the instruction to start transfer is transmitted from the controller 2 to the command address bus CA_bus. Afterward, the SCE packet PK18 is received by the memory chip 3_LUN1.

At timing t17, the data DT2 of the size DS2 designated in the packet PK2 starts to be transmitted from the memory chip 3_LUN1 to the data bus DQ_bus.

At timing t18, the size of the data DT4 reaches DS2, and the transmission of the data DT4 from the memory chip 3_LUN1 to the command address bus CA_bus is completed.

At timing t19, the data bus DQ_bus is released by the memory chip 3_LUN1 upon completion of the transmission of the data DT4. This allows other memory chips 3_LUN0, 3_LUN2, and 3_LUN3 to use the data bus DQ_bus.

At timing t20, a “Pre-defined Trans Num LUN0 size0” packet PK3 including the identification information “LUN0” on the memory chip 3_LUN0 and the designation of size “0” is transmitted from the controller 2 to the command address bus CA_bus. Afterward, the “Pre-defined Trans Num LUN0 size0” packet PK3 is received by the memory chip 3_LUN0. Accordingly, the continuous application of the “Pre-defined Trans Num LUN0” packet PK1 in the memory chip 3_LUN0 is finished.

At timing t21, a “Pre-defined Trans Num LUN1 size0” packet PK3a including the identification information “LUN1” on the memory chip 3_LUN1 and the designation of size “0” is transmitted from the controller 2 to the command address bus CA_bus. Afterward, the “Pre-defined Trans Num LUN1 size0” packet PK3a is received by the memory chip 3_LUN1. Accordingly, the continuous application of the “Pre-defined Trans Num LUN1” packet PK2 in the memory chip 3_LUN1 is finished.

As described above, in the first embodiment, in the communication method, the packet PK1 including the identification information on the memory chip 3 and size designation can be issued and transmitted by the controller 2, and can be received and recognized by the memory chip 3. This allows the memory chip 3 that has transmitted data of the designated size to the data bus to release the data bus after the transmission is completed. That is, it is possible to cause the memory chip 3 at a recipient of the packet PK1 to release the data bus without transmitting and receiving the SCT packet recommended as transfer completion notifications in the SCA protocol, thereby being able to suppress degradation of transfer performance due to the SCT issuance time. That is, the data transfer from the memory chip 3 to the data bus can be performed efficiently.

Note that the packet PK including the identification information on the memory chip 3 and size designation may include one packet or multiple packets. In the first embodiment, an example is illustrated where the packet PK including the identification information on the memory chip 3 and size designation includes one packet.

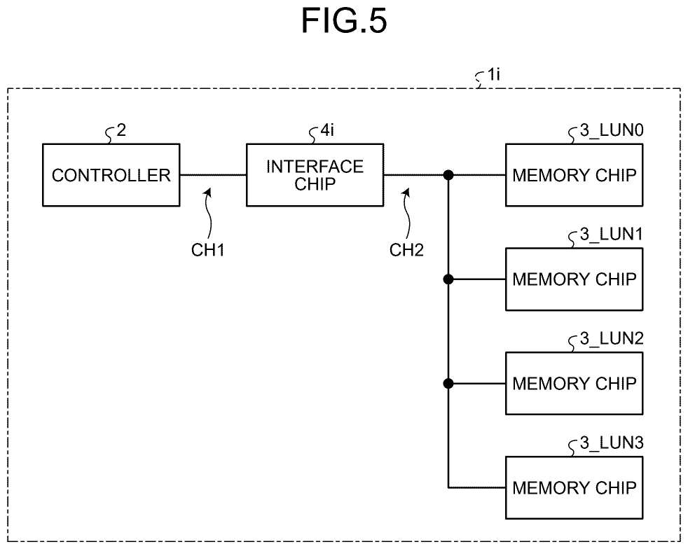

Alternatively, as a modification of the first embodiment, a memory system 1i may include an interface chip 4i as illustrated in FIG. 5. FIG. 5 is a diagram illustrating a schematic configuration of the memory system 1i according to the modification of the first embodiment.

In the memory system 1i, the interface chip 4i is connected between the controller 2 and the multiple memory chips 3_LUN0 to 3_LUN3. The interface chip 4i is connected to the controller 2 via the channel CH1, and is connected to each of the multiple memory chips 3_LUN0 to 3_LUN3 via the channel CH2.

Each of the channels CH1 and CH2 is constructed based on a predetermined standard. If each memory chip 3 is a NAND flash memory, the predetermined standard is, for example, the toggle DDR standard. The predetermined standard may support the SCA protocol in the toggle DDR standard.

Each of the channels CH1 and CH2 includes multiple signal lines. Each of the channels CH1 and CH2 may include the command address bus CA_bus, the clock line CA_CLK, the data bus DQ_bus, and the read enable line RE⁻/RE.

This configuration makes it possible to reduce the external load of each memory chip 3 and to accelerate the data transfer between the controller 2 and the memory chip 3.

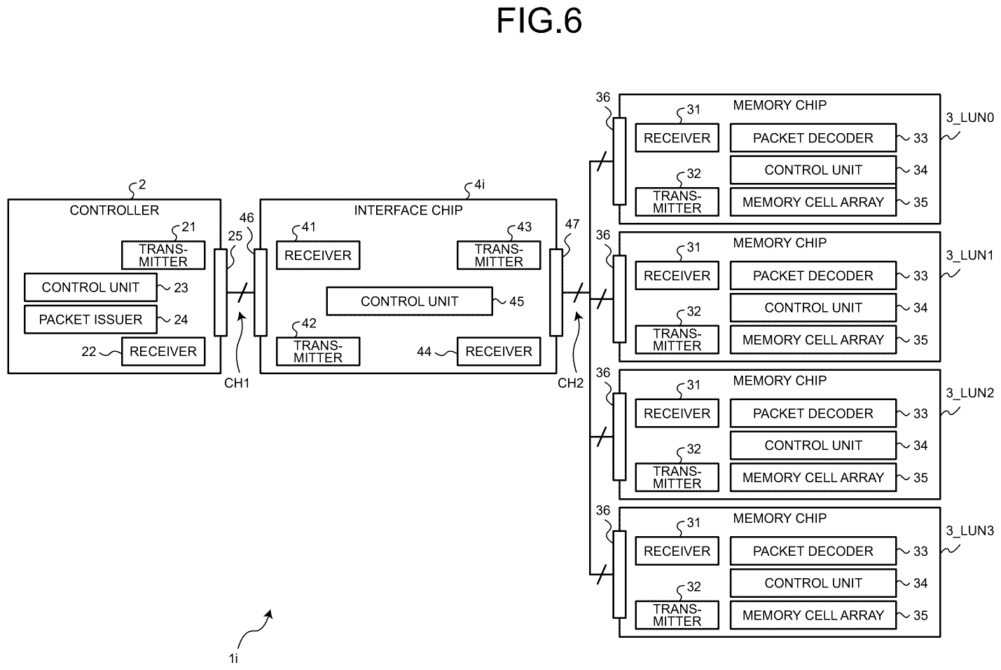

The interface chip 4i includes, as illustrated in FIG. 6, a receiver 41, a transmitter 42, a transmitter 43, a receiver 44, a control unit 45, a channel interface 46, and a channel interface 47. FIG. 6 is a diagram illustrating the configuration of the memory system 1i according to the modification of the first embodiment.

The channel interface 46 is connected to the channel CH1. The channel interface 46 performs interface operations for the channel CH1.

The channel interface 47 is connected to the channel CH2. The channel interface 47 performs interface operations for the channel CH2.

The receiver 41 receives the packet PK via the command address bus CA_bus.

When the packet PK is received by the receiver 41, the control unit 45 supplies the packet PK to the transmitter 43.

The transmitter 43 transfers the packet PK to the memory chip 3 via the command address bus CA_bus.

The receiver 44 receives the data DT via the data bus DQ_bus.

When the data DT is received by the receiver 44, the control unit 45 supplies the data DT to the transmitter 42.

The transmitter 42 transfers the data DT to the controller 2 via the data bus DQ_bus.

The interface chip 4i transfers packets and data as they are between the controller 2 or the memory chip 3. The communication method performed in the memory system 1i is similar to the communication method illustrated in FIGS. 3 and 4.

In such a memory system 1i as well, the packet PK1 including the identification information on the memory chip 3 and size designation can be issued and transmitted by the controller 2, and can be received and recognized by the memory chip 3. This allows the memory chip 3 that has transmitted data of the designated size to the data bus to release the data bus after the transmission is completed.

### Second Embodiment

Next, a memory system 1 according to a second embodiment will be described. The following will mainly describe differences from the first embodiment.

In the first embodiment, the transmission and reception of packets including size designation and data transfer using those packets is illustrated, whereas in the second embodiment, termination of data transfer using those packets is illustrated.

When data transfer using a packet PK1 including size designation is to be terminated midway, a packet issuer 24 of a controller 2 illustrated in FIG. 2 may issue a select chip terminate (SCT) packet PK21 including identification information “LUN0” on a memory chip 3_LUN0 and an instruction to complete transfer. The SCT packet is defined in the SCA protocol.

When the SCT packet PK21 is issued by the packet issuer 24, a control unit 23 waits until timing to transmit the packet PK21. When the timing to transmit the SCT packet PK21 arrives, the control unit 23 supplies the SCT packet PK21 to a transmitter 21.

The transmitter 21 transmits the SCT packet PK21 to a command address bus CA_bus. This allows the controller 2 to ensure that the data transfer using the packet PK1 including the size designation be terminated midway by the memory chip 3.

A receiver 31 of the memory chip 3 checks the identification information on the memory chip 3 included in the SCT packet PK21. When the identification information on the memory chip 3 included in the SCT packet PK21 matches identification information on the memory chip 3 itself, the receiver 31 receives the SCT packet PK21 via the command address bus CA_bus.

A control unit 34 waits until the packet PK21 is received, and when the packet PK21 is received by the receiver 31, the control unit 34 passes the packet PK21 to a packet decoder 33.

The packet decoder 33 decodes the packet PK21, extracts the instruction to complete transfer from the packet PK1, and passes the instruction to a transmitter 32 via the control unit 34.

The transmitter 32 terminates midway transmission of data DT to a data bus DQ_bus in response to the instruction to complete transfer.

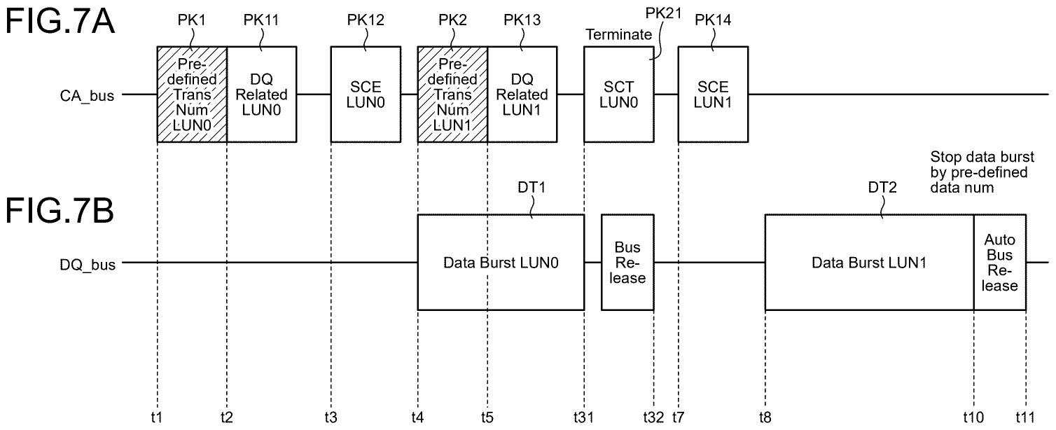

The communication method differs from the communication method in the first embodiment in the following points, as illustrated in FIGS. 7A and 7B. FIGS. 7A and 7B are diagrams illustrating the communication method according to the second embodiment. In FIGS. 7A and 7B, the horizontal axis is time. FIG. 7A illustrates the sequence of packets transferred via the command address bus CA_bus. FIG. 7B illustrates the sequence of data transferred via the data bus DQ_bus.

After operations similar to operations in the first embodiment are performed at timing t1 to t5, the SCT packet PK21 including the identification information “LUN0” on the memory chip 3_LUN0 and the instruction to complete transfer is transmitted from the controller 2 to the command address bus CA_bus at timing t31. Afterward, the SCT packet PK21 is received by the memory chip 3_LUN0.

In response, the transmission of data DT1 from the memory chip 3_LUN0 to the data bus DQ_bus is terminated midway.

At timing t32, the data bus DQ_bus is released by the memory chip 3_LUN0. This allows other memory chips 3_LUN1 to 3_LUN3 to use the data bus DQ_bus.

At timing t7, an SCE packet PK14 including identification information “LUN1” on the memory chip 3_LUN1 and an instruction to start transfer is transmitted from the controller 2 to the command address bus CA_bus. Afterward, the SCE packet PK14 is received by the memory chip 3_LUN1.

Afterward, operations similar to the operations in the first embodiment are performed after timing t8.

As described above, in the second embodiment, in the communication method, the packet PK21 including the identification information on the memory chip 3 and the instruction to finish transfer can be issued and transmitted by the controller 2, and can be received and recognized by the memory chip 3. This allows the transfer of data of the designated size to be terminated midway, enabling the memory chip 3 to release the data bus. cl Third Embodiment

Next, a memory system 1 according to a third embodiment will be described. The following will mainly describe differences from the first and second embodiments.

In the first and second embodiments, the transmission and reception of packets including identification information on a memory chips 3 and size designation are illustrated, while in the third embodiment, the transmission and reception of packets including designation of all memory chips and size designation are illustrated.

A packet issuer 24 of a controller 2 illustrated in FIG. 2 may issue a packet PK4 including the designation of all memory chips and designation of a size DS1. The packet issuer 24 may issue a “Pre-defined Trans Num ALL LUN” packet including the designation of all memory chips and designation of the size DS1 as the packet PK4. The “Pre-defined Trans Num ALL LUN” packet is a packet that is not in the SCA protocol, but may be newly defined and preset by the packet issuer 24.

When the packet PK4 is issued by the packet issuer 24, a control unit 23 waits until timing to transmit the packet PK4. When the timing to transmit the packet PK4 arrives, the control unit 23 supplies the packet PK4 to a transmitter 21.

The transmitter 21 transmits the packet PK4 to a command address bus CA_bus. This allows the controller 2 to notify all memory chips 3 of the size in advance (for example, transfer byte count).

A receiver 31 of the memory chip 3 checks the designation of all memory chips included in the packet PK4. In response to the designation of all memory chips, the receiver 31 receives the packet PK4 via the command address bus CA_bus.

A control unit 34 waits until the packet PK4 is received, and when the packet PK4 is received by the receiver 31, the control unit 34 passes the packet PK4 to a packet decoder 33.

The packet decoder 33 decodes the packet PK4 and extracts the designation of all memory chips and size designation from the packet PK4. The packet decoder 33 may decode the “Pre-defined Trans Num ALL LUN” packet and extract the designation of all memory chips and size designation from the “Pre-defined Trans Num ALL LUN” packet. The “Pre-defined Trans Num” packet is a packet that is not in the SCA protocol, but may be newly defined and preset by the packet decoder 33. The packet decoder 33 passes the designation of all memory chips and the size designation as a decoding result to the control unit 34.

The control unit 34 reads data DT of the designated size from a memory cell array 35 and waits until timing to transmit the data. When the timing to transmit the data arrives, the read data is passed to a transmitter 32 and the size designation is notified to the transmitter 32.

The transmitter 32 transmits the data DT of the designated size to a data bus DQ_bus.

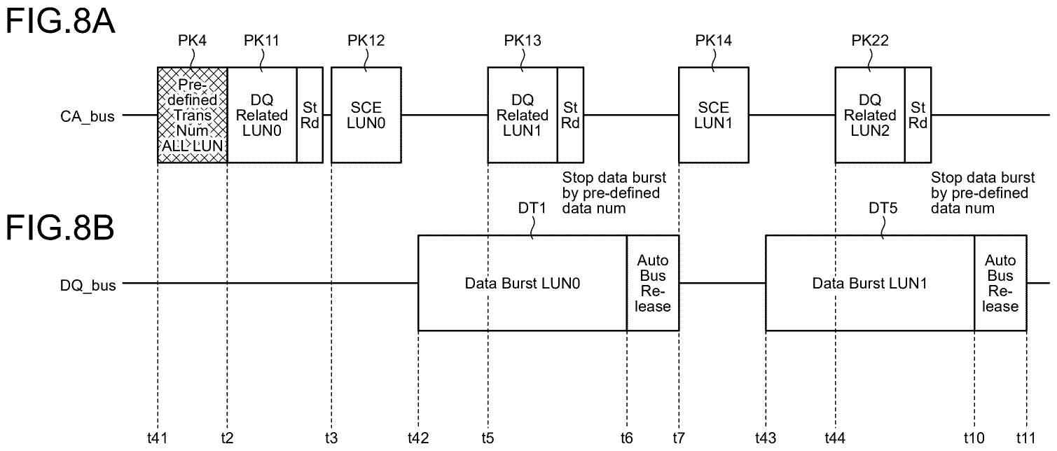

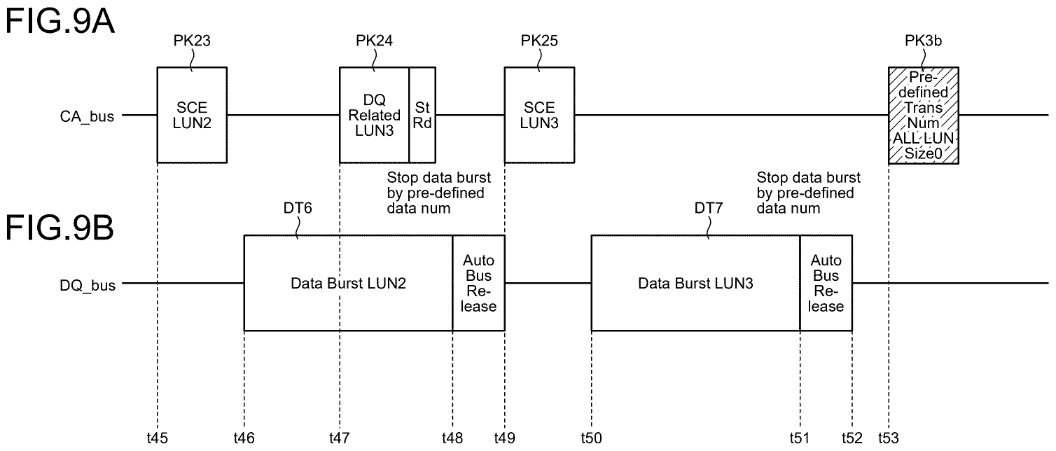

The communication method differs from the communication method in the first embodiment in the following points, as illustrated in FIGS. 8A, 8B, 9A, and 9B. FIGS. 8A, 8B, 9A, and 9B are each diagrams illustrating the communication method according to the third embodiment. In each of FIGS. 8A, 8B, 9A, and 9B, the horizontal axis is time. FIGS. 8A and 9A each illustrate the sequence of packets transferred via the command address bus CA_bus. FIGS. 8B and 9B each illustrate the sequence of data transferred via the data bus DQ_bus.

At timing t41, the “Pre-defined Trans Num ALL LUN” packet PK4 including the designation of all memory chips “ALL LUN” and the size designation DS1 is transmitted from the controller 2 to the command address bus CA_bus. Afterward, the “Pre-defined Trans Num ALL LUN” packet PK4 is received by each of the memory chip 3_LUN0 to the memory chip 3_LUN3.

Operations similar to the operations in the first embodiment are performed at timing t2 to t3.

At timing t42, in response to an SCE packet PK12 including identification information “LUN0” on the memory chip 3_LUN0 and an instruction to start transfer, data DT1 of the size DS1 designated in the packet PK4 starts to be transmitted from the memory chip 3_LUN0 to the data bus DQ_bus.

Operations similar to the operations in the first embodiment are performed at timing t5 to t7.

At timing t43, in response to an SCE packet PK14 including the identification information “LUN1” on the memory chip 3_LUN1 and the instruction to start transfer, data DT5 of the size DS1 designated in the packet PK4 starts to be transmitted from the memory chip 3_LUN1 to the data bus DQ_bus.

At timing t44, a “DQ Related LUN2” packet PK22 including identification information “LUN2” on the memory chip 3_LUN2 and a transfer instruction is transmitted from the controller 2 to the command address bus CA_bus. Afterward, the “DQ Related LUN2” packet PK22 is received by the memory chip 3_LUN2.

At timing t45, an SCE packet PK23 including the identification information “LUN2” on the memory chip 3_LUN2 and the instruction to start transfer is transmitted from the controller 2 to the command address bus CA_bus. Afterward, the SCE packet PK23 is received by the memory chip 3_LUN2.

At timing t46, data DT6 of the size DS1 designated in the packet PK4 starts to be transmitted from the memory chip 3_LUN2 to the data bus DQ_bus.

At timing t47, a “DQ Related LUN3” packet PK24 including identification information “LUN3” on the memory chip 3_LUN3 and the transfer instruction is transmitted from the controller 2 to the command address bus CA_bus. Afterward, the “DQ Related LUN3” packet PK22 is received by the memory chip 3_LUN3.

At timing t48, the size of the data DT6 reaches DS1, and the transmission of the data DT6 from the memory chip 3_LUN2 to the command address bus CA_bus is completed.

At timing t49, the data bus DQ_bus is released by the memory chip 3_LUN2 in response to completion of the transmission of the data DT6. This allows other memory chips 3_LUN0, 3_LUN1, and 3_LUN3 to use the data bus DQ_bus.

In response, an SCE packet PK25 including the identification information “LUN3” on the memory chip 3_LUN3 and the instruction to start transfer is transmitted from the controller 2 to the command address bus CA_bus. Afterward, the SCE packet PK25 is received by the memory chip 3_LUN3.

At timing t50, the data DT6 of the size DS1 designated in the packet PK4 starts to be transmitted from the memory chip 3_LUN3 to the data bus DQ_bus.

At timing t51, the size of data DT7 reaches DS1, and the transmission of the data DT7 from the memory chip 3_LUN3 to the command address bus CA_bus is completed.

At timing t52, in response to completion of the transmission of the data DT7, the data bus DQ_bus is released by the memory chip 3_LUN3. This allows other memory chips 3_LUN0 to 3_LUN2 to use the data bus DQ_bus.

At timing t53, a “Pre-defined Trans Num ALL LUN0 size0” packet PK3b including the designation “ALL LUN” of all memory chips and the designation of size “0” is transmitted from the controller 2 to the command address bus CA_bus. Afterward, the “Pre-defined Trans Num ALL LUN0 size0” packet PK3b is received by each of the memory chip 3_LUN0 to the memory chip 3_LUN3. Accordingly, the continuous application of the “Pre-defined Trans Num ALL LUN” packet PK4 in each of the memory chip 3_LUN0 to the memory chip 3_LUN3 is finished.

As described above, in the third embodiment, in the communication method, the packet PK4 including the designation of all memory chips 3 and the size designation can be issued and transmitted by the controller 2, and can be received and recognized by each memory chip 3. This allows each memory chip 3 to sequentially transmit data of the designated size to the data bus, and allows each memory chip 3 to release the data bus after transmission is completed. That is, it is possible to cause each memory chip 3 at a recipient of the packet PK4 to release the data bus without transmitting and receiving the SCT packet recommended as transfer completion notifications in the SCA protocol, thereby being able to suppress degradation of transfer performance due to the SCT issuance time. That is, the data transfer from the memory chip 3 to the data bus can be performed efficiently.

### Fourth Embodiment

Next, a memory system 1 according to a fourth embodiment will be described. The following will mainly describe differences from the first to third embodiments.

In the third embodiment, the transmission and reception of packets including designation of all memory chips and size designation and data transfer via the packets are illustrated, while in the fourth embodiment, termination of the data transfer is illustrated.

When it is desired to terminate midway the data transfer using a packet PK4 including the designation of all memory chips and the designation of a size DS1 for a specific memory chip 3, a packet issuer 24 of a controller 2 illustrated in FIG. 2 may issue an SCT packet PK26 including identification information on the memory chip 3 and an instruction to complete transfer.

When the SCT packet PK26 is issued by the packet issuer 24, a control unit 23 waits until timing to transmit the SCT packet PK26. When the timing to transmit the SCT packet PK26 arrives, the control unit 23 supplies the SCT packet PK26 to a transmitter 21.

The transmitter 21 transmits the SCT packet PK26 to a command address bus CA_bus. This allows the controller 2 to ensure that the data transfer using the packet PK4 including the designation of all memory chips and designation of the size DS1 be terminated midway by the specific memory chip 3.

A receiver 31 of the memory chip 3 checks the identification information on the memory chip 3 included in the SCT packet PK26. When the identification information on the memory chip 3 included in the SCT packet PK26 matches identification information on the memory chip 3 itself, the receiver 31 receives the SCT packet PK26 via the command address bus CA_bus.

A control unit 34 waits until the SCT packet PK26 is received, and when the SCT packet PK26 is received by the receiver 31, the control unit 34 passes the SCT packet PK26 to a packet decoder 33.

The packet decoder 33 decodes the SCT packet PK26, extracts the instruction to complete transfer from the SCT packet PK26, and passes the instruction to a transmitter 32 via the control unit 34.

In response to the instruction to complete transfer, the transmitter 32 terminates midway the transmission of the data DT to a data bus DQ_bus.

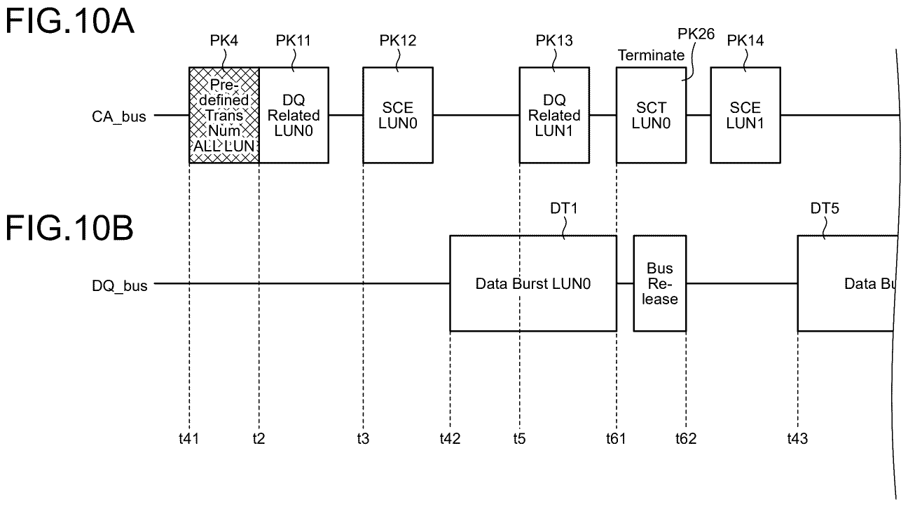

As illustrated in FIGS. 10A and 10B, the communication method differs from the communication method in the third embodiment in the following points. FIGS. 10A and 10B are diagrams illustrating the communication method according to the fourth embodiment. In FIGS. 10A and 10B, the horizontal axis is time. FIG. 10A illustrates the sequence of packets transferred via the command address bus CA_bus. FIG. 10B illustrates the sequence of data transferred via the data bus DQ_bus.

After operations similar to the operations in the third embodiment are performed at timing t41 to t5, the SCT packet PK26 including identification information “LUN0” on the memory chip 3_LUN0 and the instruction to complete transfer is transmitted from the controller 2 to the command address bus CA_bus at timing t61. Afterward, the SCT packet PK26 is received by the memory chip 3_LUN0.

In response, the transmission of data DT1 from the memory chip 3_LUN0 to the data bus DQ_bus is terminated midway.

At timing t62, the data bus DQ_bus is released by the memory chip 3_LUN0. This allows other memory chips 3_LUN1 to 3_LUN3 to use the data bus DQ_bus.

At timing t43, in response to an SCE packet PK14 including identification information “LUN1” on the memory chip 3_LUN1 and an instruction to start transfer, data DT5 of the size DS1 designated in the packet PK4 starts to be transmitted from the memory chip 3_LUN1 to the data bus DQ_bus.

Afterward, operations similar to operations in the third embodiment are performed after timing t44.

As described above, in the fourth embodiment, in the communication method, the packet PK26 including the identification information on the memory chip 3 and the instruction to finish transfer can be issued and transmitted by the controller 2, and can be received and recognized by the memory chip 3. This makes it possible to cause the specific memory chip 3 to terminate midway the transfer of data of the size designated in the packet PK4 including the designation of all memory chips 3 and the size designation, and to cause the memory chip 3 to release the data bus.

### Fifth Embodiment

Next, a memory system 1 according to a fifth embodiment will be described. The following will mainly describe differences from the first to fourth embodiments.

In the first to fourth embodiments, the data transfer start of the memory chip 3 in response to the SCE packet is illustrated, while in the fifth embodiment, the data transfer start of the memory chip 3 in response to a notification from a signal line is illustrated.

A channel CH illustrated in FIG. 2 may further include a ready/busy signal line Rd/Bsy, in addition to a command address bus CA_bus, a clock line CA_CLK, a data bus DQ_bus, and a read enable line RE⁻/RE. The ready/busy signal line Rd/Bsy is used to transmit a ready/busy signal, which is a signal to notify the access state of the memory chip 3.

The ready/busy signal line Rd/Bsy may be assigned to be used for notification of data transfer completion from the memory chip 3, instead of notification of the access state of the memory chip 3.

A packet issuer 24 of a controller 2 may issue a packet PK5 including designation of assignment for transfer completion notification of the ready/busy signal line Rd/Bsy. The packet issuer 24 may issue a “Next Trigger” packet including designation of assignment for transfer completion notification of the ready/busy signal line Rd/Bsy as the packet PK5. The “Next Trigger” packet is a packet that is not in the SCA protocol, but may be newly defined and preset by the packet issuer 24.

When the packet PK5 is issued by the packet issuer 24, a control unit 23 waits until timing to transmit the packet PK5. When the timing to transmit the packet PK5 arrives, the control unit 23 provides the packet PK5 to a transmitter 21.

The transmitter 21 transmits the packet PK5 to the command address bus CA_bus. This allows the controller 2 to notify each memory chip 3 to transmit a Next Trigger signal, which is a signal to notify the data transfer completion, to the ready/busy signal line Rd/Bsy.

A receiver 31 of the memory chip 3 confirms that the packet PK5 does not contain identification information on the memory chip or designation of all memory chips. In response, the receiver 31 receives the packet PK5 via the command address bus CA_bus.

A control unit 34 waits until the packet PK5 is received, and when the packet PK5 is received by the receiver 31, the control unit 34 passes the packet PK5 to a packet decoder 33.

The packet decoder 33 decodes the packet PK5 and extracts, from the packet PK5, designation of assignment for transfer completion notification of the ready/busy signal line Rd/Bsy. The packet decoder 33 may decode the “Next Trigger” packet and extract, from the “Next Trigger” packet, the designation of assignment for transfer completion notification of the ready/busy signal line Rd/Bsy. The “Next Trigger” packet is a packet that is not in the SCA protocol, but may be newly defined and preset by the packet decoder 33. The packet decoder 33 passes the designation of assignment for transfer completion notification of the ready/busy signal line Rd/Bsy to the control unit 34 as a decoding result.

In response to the designation of assignment for transfer completion notification of the ready/busy signal line Rd/Bsy, the control unit 34 generates the active-level Next Trigger signal when the data transfer is completed and passes the signal to a transmitter 32.

The transmitter 32 transmits the active-level Next Trigger signal to the ready/busy signal line Rd/Bsy. This makes it possible to notify other memory chips 3 of data transfer completion by the memory chip 3.

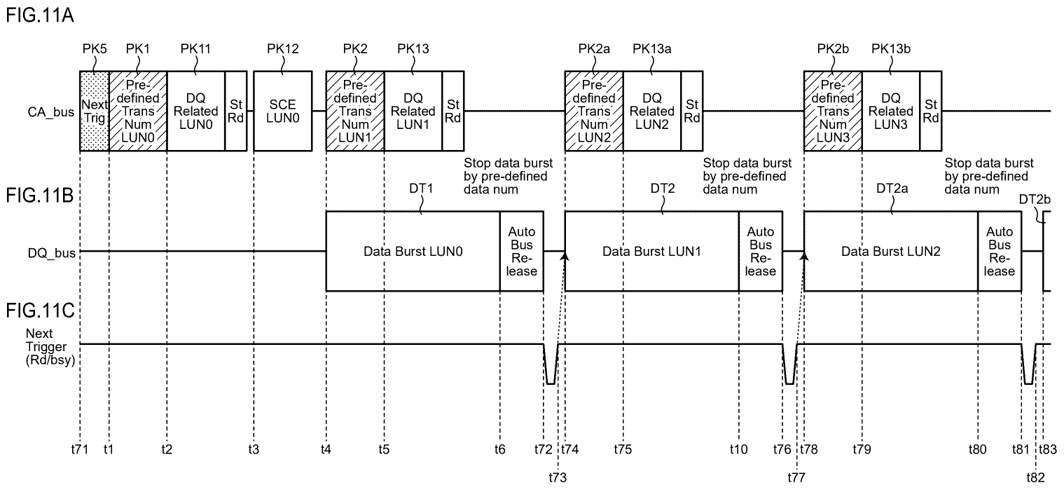

The communication method differs from the communication method in the first embodiment in the following points, as illustrated in FIGS. 11A to 11C. FIGS. 11A to 11C are diagrams illustrating the communication method according to the fifth embodiment. In FIGS. 11A to 11C, the horizontal axis is time. FIG. 11A illustrates the sequence of packets transferred via the command address bus CA_bus. FIG. 11B illustrates the sequence of data transferred via the data bus DQ_bus. FIG. 11C illustrates the sequence of the Next Trigger signal transferred via the ready/busy signal line Rd/Bsy.

At timing t71, the “Next Trigger” packet PK5 including the designation of assignment for transfer completion notification of the ready/busy signal line Rd/Bsy is transmitted from the controller 2 to the command address bus CA_bus. Afterward, the “Next Trigger” packet PK5 is received by each of the memory chips 3_LUN0 to 3_LUN3.

After operations similar to operations in the first embodiment are performed at timing t1 to t6, in response to the completion of the transmission of data DT1, the data bus DQ_bus is released by the memory chip 3_LUN0 at timing t72. This allows other memory chips 3_LUN1 to 3_LUN3 to use the data bus DQ_bus.

At the same time, the Next Trigger signal transitions from a non-active level to an active level, and the active-level Next Trigger signal is transmitted from the memory chip 3_LUN0 to the ready/busy signal line Rd/Bsy.

At timing t73, the Next Trigger signal transitions from an active level to a non-active level, and the non-active level Next Trigger signal is transmitted from the memory chip 3_LUN0 to the ready/busy signal line Rd/Bsy.

At timing t74, in response to the Next Trigger signal transitioning from a non-active level to an active level and back to a non-active level, the completion of data transfer by the memory chip 3_LUN0 is recognized by the memory chip 3_LUN1. In response, data DT2 of the size DS2 designated in the packet PK2 starts to be transmitted from the memory chip 3_LUN1 to the data bus DQ_bus.

In parallel, a “Pre-defined Trans Num LUN2” packet PK2a including identification information “LUN2” on the memory chip 3_LUN2 and the designation of the size DS2a is transmitted from the controller 2 to the command address bus CA_bus. Afterward, the “Pre-defined Trans Num LUN2” packet PK2a is received by the memory chip 3_LUN2.

At timing t75, a “DQ Related LUN2” packet PK13a including the identification information “LUN2” on the memory chip 3_LUN2 and a transfer instruction is transmitted from the controller 2 to the command address bus CA_bus. Afterward, the “DQ Related LUN2” packet PK13a is received by the memory chip 3_LUN2.

After operations similar to operations in the first embodiment are performed at timing t10, in response to the completion of the transmission of the data DT2, the data bus DQ_bus is released by the memory chip 3_LUN1 at timing t76. This allows other memory chips 3_LUN0, 3_LUN2, and 3_LUN3 to use the data bus DQ_bus.

At the same time, the Next Trigger signal transitions from a non-active level to an active level, and the active-level Next Trigger signal is transmitted from the memory chip 3_LUN1 to the ready/busy signal line Rd/Bsy.

At timing t77, the Next Trigger signal transitions from an active level to a non-active level, and the non-active level Next Trigger signal is transmitted from the memory chip 3_LUN1 to the ready/busy signal line Rd/Bsy.

At timing t78, in response to the Next Trigger signal transitioning from a non-active level to an active level and back to a non-active level, the completion of data transfer by the memory chip 3_LUN1 is recognized by the memory chip 3_LUN2. In response, data DT2a of the size DS2a designated in the packet PK2a starts to be transmitted from the memory chip 3_LUN2 to the data bus DQ_bus.

In parallel, a “Pre-defined Trans Num LUN3” packet PK2b including identification information “LUN3” on the memory chip 3_LUN3 and the designation of the size DS4 is transmitted from the controller 2 to the command address bus CA_bus. Afterward, the “Pre-defined Trans Num LUN3” packet PK2b is received by the memory chip 3_LUN3.

At timing t79, a “DQ Related LUN3” packet PK13b including the identification information “LUN3” on the memory chip 3_LUN3 and the transfer instruction is transmitted from the controller 2 to the command address bus CA_bus. Afterward, the “DQ Related LUN3” packet PK13b is received by the memory chip 3_LUN3.

At timing t80, the size of the data DT2a reaches DS2a, and the transmission of the data DT2a from the memory chip 3_LUN2 to the data bus DQ_bus is completed.

At timing t81, in response to the completion of the transmission of the data DT2a, the data bus DQ_bus is released by the memory chip 3_LUN2. This allows other memory chips 3_LUN0, 3_LUN1, and 3_LUN3 to use the data bus DQ_bus.

At the same time, the Next Trigger signal transitions from a non-active level to an active level, and the active-level Next Trigger signal is transmitted from the memory chip 3_LUN2 to the ready/busy signal line Rd/Bsy.

At timing t82, the Next Trigger signal transitions from an active level to a non-active level, and the non-active level Next Trigger signal is transmitted from the memory chip 3_LUN2 to the ready/busy signal line Rd/Bsy.

At timing t83, in response to the Next Trigger signal transitioning from a non-active level to an active level and back to a non-active level, the completion of data transfer by the memory chip 3_LUN2 is recognized by the memory chip 3_LUN3. In response, data DT2b of the size DS2b designated in the packet PK2b starts to be transmitted from the memory chip 3_LUN3 to the data bus DQ_bus.

As described above, in the fifth embodiment, in the communication method, the packet PK5 including the designation of assignment for transfer completion notification of the ready/busy signal line Rd/Bsy can be issued and transmitted by the controller 2, and can be received and recognized by each memory chip 3. This enables notification to each memory chip 3 to transmit the Next Trigger signal, which is a signal for notifying the completion of data transfer, to the ready/busy signal line Rd/Bsy. That is, without the transmission and reception of the SCE packet, which is recommended in the SCA protocol as designation for transfer start, it becomes possible for each memory chip 3 at a recipient of packets PK1, PK2, PK2a, and PK2b to start data transfer, thereby being able to suppress degradation of transfer performance due to the SCE issuance time. That is, the data transfer from the memory chip 3 to the data bus can be performed more efficiently.

### Sixth Embodiment

Next, a memory system 1 according to a sixth embodiment will be described. The following will mainly describe differences from the first to fifth embodiments.

In the fifth embodiment, the data transfer start of the individual memory chip 3 in response to the SCE packet is illustrated, while in the sixth embodiment, the data transfer start of all memory chips 3 in response to a notification from a signal line is illustrated.

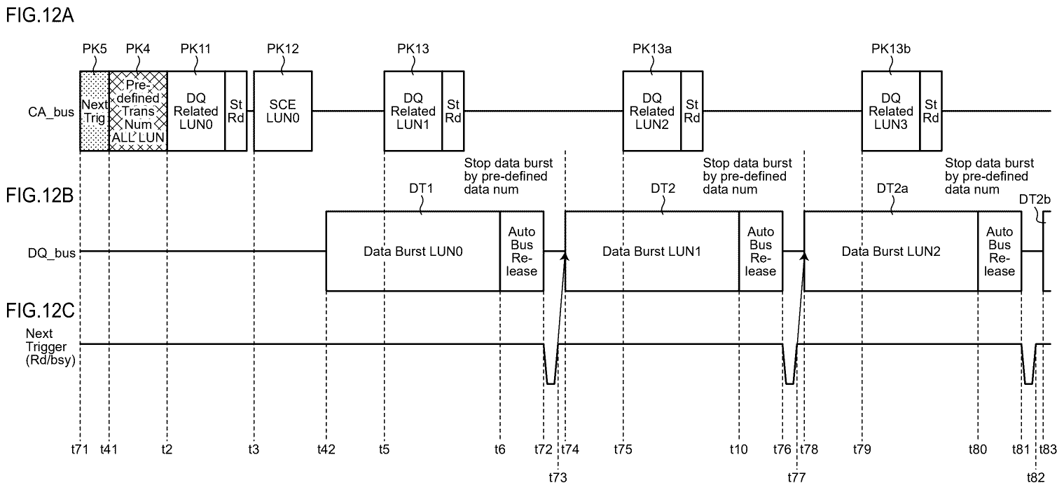

As illustrated in FIGS. 12A to 12C, the communication method differs from the communication method in the fifth embodiment in the following points. FIGS. 12A to 12C are diagrams illustrating the communication method according to the sixth embodiment.

In FIGS. 12A to 12C, the horizontal axis is time. FIG. 12A illustrates the sequence of packets transferred via a command address bus CA_bus. FIG. 12B illustrates the sequence of data transferred via a data bus DQ_bus. FIG. 12C illustrates the sequence of a Next the Trigger signal transferred via a ready/busy signal line Rd/Bsy.

At timing t71, a “Next Trigger” packet PK5 including designation of assignment for transfer completion notification of the ready/busy signal line Rd/Bsy is transmitted from a controller 2 to the command address bus CA_bus. Afterward, the “Next Trigger” packet PK5 is received by each of the memory chips 3_LUN0 to 3_LUN3.

At timing t41, a “Pre-defined Trans Num ALL LUN” packet PK4 including designation “ALL LUN” of all memory chips and designation of a size DS1 is transmitted from the controller 2 to the command address bus CA_bus. Afterward, the “Pre-defined Trans Num ALL LUN” packet PK4 is received by each of the memory chips 3_LUN0 to 3_LUN3.

After timing t2, without transmitting packets PK2, PK2a, and PK2b to the command address bus CA_bus, operations similar to operations in the fifth embodiment are performed, except that the sizes of data DT1, DT2, DT2a, and DT2b are common.

As described above, in the sixth embodiment, in the communication method, the packet PK5 including the designation of assignment for transfer completion notification of the ready/busy signal line Rd/Bsy can be issued and transmitted by the controller 2, and can be received and recognized by each memory chip 3. This enables notification to each memory chip 3 to transmit the Next Trigger signal, which is a signal for notifying data transfer completion, to the ready/busy signal line Rd/Bsy. That is, without the transmission and reception of the SCE packet, which is recommended in the SCA protocol as a designation for starting the transfer, it becomes possible for each memory chip 3 at a recipient of the packet PK4 to start data transfer sequentially, thereby being able to suppress degradation of transfer performance due to the SCE issuance time. That is, the data transfer from the memory chip 3 to the data bus can be performed more efficiently.

### Seventh Embodiment

Next, a memory system 1 according to a seventh embodiment will be described. The following will mainly describe differences from the first to sixth embodiments.

In the first to sixth embodiments, operations where the size designation in the packet PK1 is continuously applied are illustrated, while in the seventh embodiment, operations where different size designation is made by an interrupt for the continuous application are illustrated.

A packet issuer 24 of a controller 2 as illustrated in FIG. 2 may issue a packet PK6 including identification information on a memory chip 3 and size designation by an interrupt. The packet issuer 24 may issue an “Override Pre-defined Trans Num” packet including the identification information on the memory chip 3 and the size designation by an interrupt as the packet PK6. The “Override Pre-defined Trans Num” packet is a packet that is not in the SCA protocol, but may be newly defined and preset by the packet issuer 24. The number of interrupts may be one. This packet can be used when a different transfer size needs to be temporarily set during sequential access with the set transfer size when a random access for file system update occurs.

When the packet PK6 is issued by the packet issuer 24, a control unit 23 waits until timing to transmit the packet PK6. When the timing to transmit the packet PK6 arrives, the control unit 23 supplies the packet PK6 to a transmitter 21.

The transmitter 21 transmits the packet PK6 to a command address bus CA_bus. This allows the controller 2 to notify the memory chip 3 of a size different from a designation size of a packet PK1 (for example, transfer byte count).

A receiver 31 of the memory chip 3 checks the identification information on the memory chip 3 included in the packet PK6. When the identification information on the memory chip 3 included in the packet PK1 matches identification information on the memory chip 3 itself, the receiver 31 receives the packet PK6 via the command address bus CA_bus.

A control unit 34 waits until the packet PK6 is received, and when the packet PK6 is received by the receiver 31, the control unit 34 passes the packet PK6 to a packet decoder 33.

The packet decoder 33 decodes the packet PK6 and extracts the size designation by an interrupt from the packet PK6. The packet decoder 33 may decode the “Override Pre-defined Trans Num” packet and extract the size designation by an interrupt from the “Override Pre-defined Trans Num” packet. The “Override Pre-defined Trans Num” packet is a packet that is not in the SCA protocol, but may be newly defined and preset by the packet decoder 33. The packet decoder 33 passes the size designation by an interrupt as a decoding result to the control unit 34.

The control unit 34 reads data DT of the size designated by an interrupt from a memory cell array 35 and waits until timing to transmit the data. When the timing to transmit the data arrives, the read data is passed to a transmitter 32 and the size designation by an interrupt is notified to the transmitter 32.

The transmitter 32 transmits the data DT of the size designated by an interrupt to a data bus DQ_bus.

Afterward, the size designation by an interrupt in the control unit 34 and the transmitter 32 is cleared, and the continuous application of the size designation by the packet PK1 is resumed.

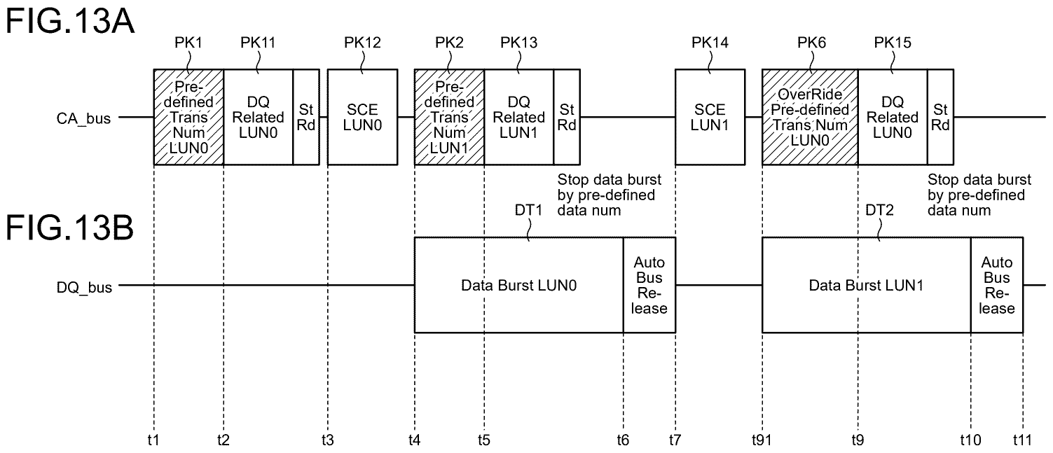

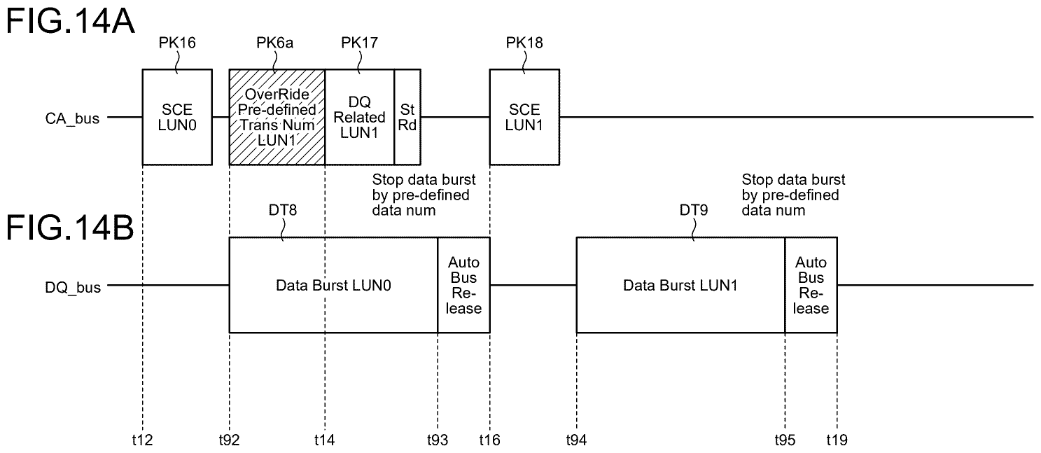

As illustrated in FIGS. 13A, 13B, 14A, and 14B, the communication method differs from the communication method in the first embodiment in the following points. FIGS. 13A, 13B, 14A, and 14B are each diagrams illustrating the communication method according to the seventh embodiment. In each of FIGS. 13A, 13B, 14A, and 14B, the horizontal axis is time. FIGS. 13A and 14A each illustrate the sequence of packets transferred via the command address bus CA_bus. FIGS. 13B and 14B illustrate the sequence of data transferred via the data bus DQ_bus.

After operations similar to operations in the first embodiment are performed at timing t1 to t7, the “Override Pre-defined Trans Num” packet PK6 including identification information “LUN0” on a memory chip 3_LUN0 and designation of a size DS11 by an interrupt is transmitted from the controller 2 to the command address bus CA_bus at timing t91. The size DS11 is different from the size DS1 designated in the packet PK1. Afterward, the “Override Pre-defined Trans Num” packet PK6 is received by the memory chip 3_LUN0.

At the same time, data DT2 of a size DS2 designated in a packet PK2 starts to be transmitted from a memory chip 3_LUN1 to the data bus DQ_bus.

After operations similar to operations in the first embodiment are performed at timing t9 to t12, the “Override Pre-defined Trans Num” packet PK6a including identification information “LUN1” on a memory chip 3_LUN1 and designation of a size DS12 by an interrupt is transmitted from the controller 2 to the command address bus CA_bus at timing t92. Afterward, the “Override Pre-defined Trans Num” packet PK6a is received by the memory chip 3_LUN1.

At the same time, data DT8 of the size DS11 designated by an interrupt in a packet PK6 starts to be transmitted from a memory chip 3_LUN0 to the data bus DQ_bus.

After operations similar to operations in the first embodiment are performed at timing t14, the size of the data DT8 reaches DS11, and the transmission of the data DT8 from the memory chip 3_LUN0 to the command address bus CA_bus is completed at timing t93.

After operations similar to operations in the first embodiment are performed at timing t16, data DT9 of the size DS12 designated by an interrupt in the packet PK6a starts to be transmitted from the memory chip 3_LUN1 to the data bus DQ_bus at timing t94.

At timing t95, the size of the data DT9 reaches DS12, and the transmission of the data DT9 from the memory chip 3_LUN1 to the command address bus CA_bus is completed.

As described above, in the seventh embodiment, in the communication method, the packet PK6 including the identification information on the memory chip 3 and the size designation by an interrupt can be issued and transmitted by the controller 2, and can be received and recognized by the memory chip 3. In a state where the data transfer of the size designated in the packet PK1 is continuously applied, this enables temporary transfer of data of the size designated by an interrupt in the packet PK6. This can improve the flexibility of size designation in data transfer.

### Eighth Embodiment

Next, a memory system 1j according to an eighth embodiment will be described. The following will mainly describe differences from the first to seventh embodiments.

In the first to seventh embodiments, size designation using the packet PK1 is illustrated, while in the eighth embodiment, size designation through the setting of a feature register in a memory chip 3j is illustrated.

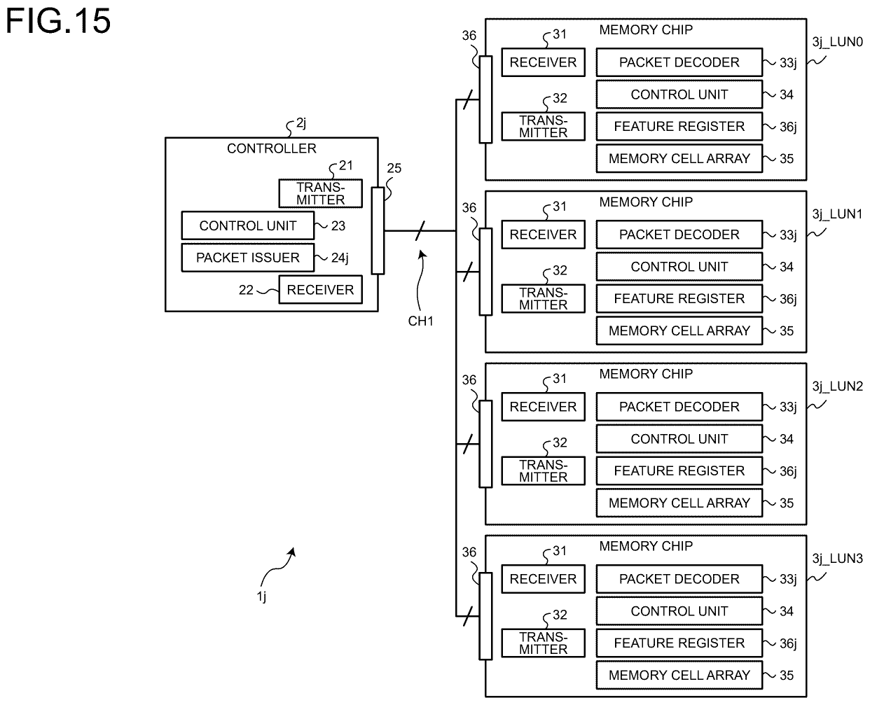

In the memory system 1j, each memory chip 3j may further include a feature register 36j, as illustrated in FIG. 15. The feature register 36j is configured to allow a parameter for data size designation to be set.

A packet issuer 24j of a controller 2j issues a packet PK7 including identification information on the memory chip 3j and designation for storing a size parameter in the feature register 36j. The packet issuer 24j may issue a “Set Feature”command packet as the packet PK7. The “Set Feature” command packet is defined in the SCA protocol to designate and transmit a Set Feature command as an argument within a packet when transmitting a command packet.

The “Set Feature” command packet can be issued to release a data bus DQ_bus after transferring data of a size designated in a size parameter at a recipient by designating the storage of the size parameter. The size parameter set in the feature register 36j, after being once issued, is continuously applied at a recipient. The “Set Feature” command packet can also be issued to finish this continuous application at a recipient by including designation to store a zero-size size parameter.

When the packet PK7 is issued by the packet issuer 24j, a control unit 23 waits until timing to transmit the packet PK7. When the timing to transmit the packet PK7 arrives, the control unit 23 supplies the packet PK7 to a transmitter 21.

The transmitter 21 transmits the packet PK7 to a command address bus CA_bus. This allows the controller 2j to instruct the memory chip 3j in advance to store the size parameter of the size (for example, transfer byte count).

A receiver 31 checks the identification information on the memory chip 3j included in the packet PK7. If the identification information on the memory chip 3j included in the packet PK7 matches identification information on the memory chip itself, the receiver 31 receives the packet PK7 via the command address bus CA_bus.

A control unit 34 waits until the packet PK7 is received, and when the packet PK7 is received by the receiver 31, the control unit 34 passes the packet PK7 to a packet decoder 33j.

The packet decoder 33j decodes the packet PK7 and extracts the designation for storing the size parameter from the packet PK7. The packet decoder 33j may decode the “Set Feature” command packet and extract the designation for storing the size parameter from the “Set Feature” command packet. The “Set Feature” command packet is a packet that is not in the SCA protocol, but may be newly defined and preset by the packet decoder 33j. The packet decoder 33j passes the designation for storing the size parameter as a decoding result to the control unit 34.

The control unit 34 accesses the feature register 36j and sets the designated size parameter in the feature register 36j. The control unit 34 reads data DT of the size designated in the size parameter from a memory cell array 35, passes the read data to a transmitter 32, and notifies the transmitter 32 of the size designation set in the size parameter.

The transmitter 32 transmits the data DT of the size designated in the size parameter to the data bus DQ_bus.

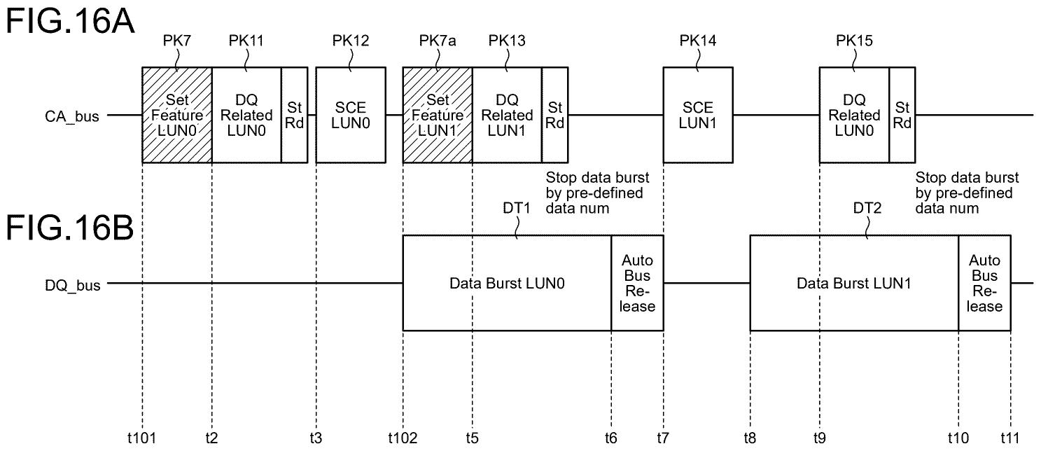

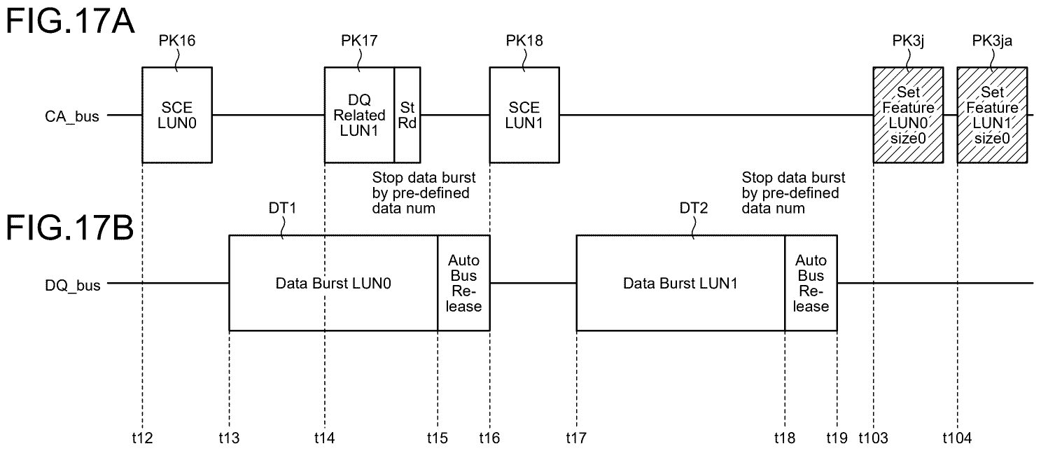

As illustrated in FIGS. 16A, 16B, 17A, and 17B, the communication method differs from the communication method in the first embodiment in the following points. FIGS. 16A, 16B, 17A, and 17B are each diagrams illustrating the communication method according to the eighth embodiment. In each of FIGS. 16A, 16B, 17A, and 17B, the horizontal axis is time. FIGS. 16A and 17A each illustrate the sequence of packets transferred via the command address bus CA_bus. FIGS. 16B and 17B illustrate the sequence of data transferred via the data bus DQ_bus.

At timing t101, the “Set Feature” command packet PK7 including identification information “LUN0” on a memory chip 3j_LUN0 and designation for storing the size parameter indicating a size DS1 is transmitted from the controller 2j to the command address bus CA_bus. Afterward, the “Set Feature” command packet PK7 is received by the memory chip 3j_LUN0, and the size parameter indicating the size DS1 is stored in the feature register 36j of the memory chip 3j_LUN0.

After operations similar to the operations in the first embodiment are performed at timing t2 to t3, data DT1 of the size DS1 designated in the size parameter in the feature register 36j starts to be transmitted from the memory chip 3j_LUN0 to the data bus DQ_bus at timing t102.

In parallel, a “Set Feature” command packet PK7a including identification information “LUN1” on a memory chip 3jLUN1 and designation for storing the size parameter indicating a size DS2 is transmitted from the controller 2j to the command address bus CA_bus. Afterward, the “Set Feature” command packet PK7a is received by the memory chip 3jLUN1, and the size parameter indicating the size DS2 is stored in the feature register 36j of the memory chip 3jLUN1.

After operations similar to the operations in the first embodiment are performed at timing t5 to t19, a “Set Feature” command packet PK3j including the identification information “LUN0” on the memory chip 3j_LUN0 and the designation for storing the size parameter indicating size “0” is transmitted from the controller 2j to the command address bus CA_bus at timing t103. Afterward, the “Set Feature” command packet PK3j is received by the memory chip 3j_LUN0. As a result, the continuous application of the size parameter of the feature register 36j in the memory chip 3j_LUN0 is finished.

At timing t104, a “Set Feature” command packet PK3ja including the identification information “LUN1” on the memory chip 3jLUN1 and the designation for storing the size parameter indicating size “0” is transmitted from the controller 2j to the command address bus CA_bus. Afterward, the “Set Feature” command packet PK3ja is received by the memory chip 3jLUN1. As a result, the continuous application of the size parameter of the feature register 36j in the memory chip 3jLUN1 is finished.

As described above, in the eighth embodiment, in the communication method, the packet PK7 including the identification information on the memory chip 3j and the designation for storing the size parameter can be issued and transmitted by the controller 2j, and can be received and recognized by the memory chip 3j. This makes it possible for the memory chip 3j that has transmitted the data of the size designated in the size parameter to the data bus to release the data bus after completing the transmission. That is, it becomes possible for the memory chip 3j, which is a recipient of the packet PK7, to release the data bus without the transmission and reception of the SCT packet, which is recommended as a transfer completion notification in the SCA protocol, thereby being able to suppress degradation of transfer performance due to the SCT issuance time. That is, data transfer from the memory chip 3 to the data bus can be performed efficiently.

Note that the packet issuer 24j of the controller 2j may issue a packet PK107 including designation of all memory chips and the designation for storing the size parameter in the feature register 36j. The packet issuer 24j may issue a “Set Feature” command packet including the designation of all memory chips and the designation for storing the size parameter in the feature register 36j as the packet PK107.

Alternatively, the feature register 36j of each memory chip 3j may be configured to allow the parameter indicating the assignment for transfer completion notification of the ready/busy signal line Rd/Bsy to be set.

The packet issuer 24j of the controller 2j may issue a packet PK207 including designation for storing the parameter indicating the assignment for transfer completion notification of the ready/busy signal line Rd/Bsy. The packet issuer 24j may issue a “Set Feature” command packet including designation for storing the parameter indicating the assignment for transfer completion notification of the ready/busy signal line Rd/Bsy in the feature register 36j as the packet PK207.

Alternatively, the feature register 36j of each memory chip 3j may be configured to allow the size parameter indicating the size designation by an interrupt to be set.

The packet issuer 24j of the controller 2j may issue a packet PK307 including identification information on the memory chip 3j and designation for storing the size parameter indicating the size designation by an interrupt. The packet issuer 24j may issue a “Set Feature” command packet including designation for storing the size parameter indicating the size designation by an interrupt in the feature register 36j as the packet PK307.

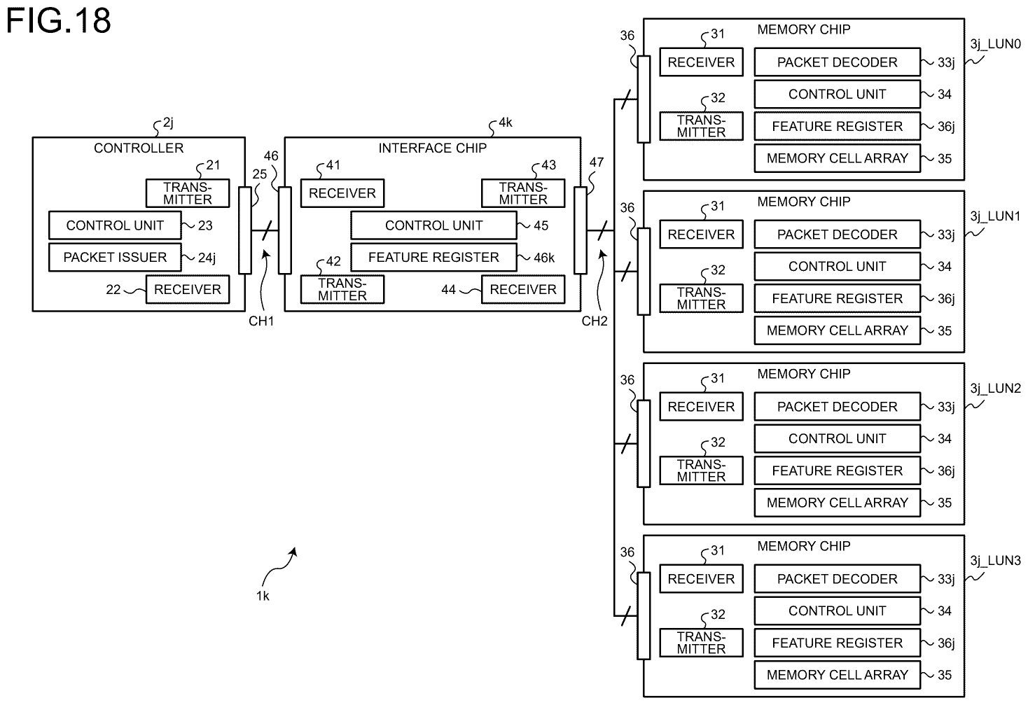

Alternatively, as a modification of the eighth embodiment, a memory system 1k may further include an interface chip 4k, as illustrated in FIG. 18. FIG. 18 is a diagram illustrating the configuration of the memory system 1j according to the modification of the eighth embodiment.

The interface chip 4k further includes a feature register 46k in addition to the interface chip 4i (see FIG. 6). The feature register 46k is configured in a similar manner to the feature register 36j of each memory chip 3j.

The interface chip 4k transfers the “Set Feature” command packet from the controller 2j as it is to the memory chip 3j. At that time, a control unit 45 of the interface chip 4k sets the size parameter designated in the “Set Feature” command packet into the feature register 46k. Except for the above points, the communication method performed in the memory system 1k is similar to the communication method illustrated in FIGS. 3 and 4.

In such a memory system 1k, the packet PK7 including the identification information on the memory chip 3j and the designation for storing the size parameter can be issued and transmitted by the controller 2j, and can be received and recognized by the memory chip 3j. This allows the memory chip 3j that has transmitted data of the size designated in the size parameter to the data bus to release the data bus after completing the transmission.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication method comprising:
transmitting a first packet from a controller to a first bus, the first packet including identification information on a first chip and designation of a first size;
enabling first data of the first size to be transferred from the first chip to a second bus in response to the first packet being received by the first chip; and
releasing the second bus after the transfer of the first data is completed.

2. The communication method according to claim 1, further comprising:
transmitting a second packet including the identification information on the first chip and an instruction to finish transfer from the controller to the first bus; and
terminating midway the transfer of data of the first size by the first chip in response to the second packet being received by the first chip during the transfer of the data of the first size.

3. The communication method according to claim 1, further comprising:
transmitting a third packet including the identification information on the first chip and designation of a zero size from the controller to the first bus; and
finishing continuous data transfer of the first size by the first chip on the second bus in response to the third packet being received by the first chip.

4. The communication method according to claim 1, wherein
a fourth packet including designation of all chips and the designation of the first size is transmitted from the controller to the first bus,
the first data of the first size is enabled to be sequentially transferred from each chip to the second bus in response to the fourth packet being received by each chip, and
upon transfer completion from each chip, the second bus is released.

5. The communication method according to claim 1, further comprising:
transmitting a fifth packet including designation of assignment for transfer completion notification of a first signal line from the controller to the first bus;
transitioning a level of the first signal line of the first chip to a level indicating the transfer completion notification after the transfer of the first data is completed in response to the fifth packet being received by the first chip; and
transferring second data from a second chip to the second bus in response to the transition of the first signal line to the level indicating the transfer completion notification.

6. The communication method according to claim 1, further comprising:
transmitting a sixth packet including the identification information on the first chip and designation of a second size by an interrupt from the controller to the first bus;
transferring second data of the second size from the first chip to the second bus by the interrupt instead of the first size in response to the sixth packet being received by the first chip; and
clearing the designation of the second size by the interrupt and releasing the second bus after the transfer of the second data is completed.

7. The communication method according to claim 1, further comprising:
transmitting a seventh packet including the identification information on the first chip and an instruction to set the first size in a feature register from the controller to the first bus;
enabling third data of the first size to be transferred from the first chip to the second bus in response to the seventh packet being received by the first chip; and
releasing the second bus after the transfer of the third data is completed.

8. The communication method according to claim 1, wherein
the communication method is performed according to a SCA protocol.

9. A controller comprising:
a packet issuer that issues a first packet including identification information on a first chip and designation of a first size; and
a transmitter that transmits the first packet to a first bus.

10. The controller according to claim 9, wherein
the packet issuer further issues a second packet including the identification information on the first chip and an instruction to finish transfer; and
the transmitter further transmits the second packet to the first bus.

11. The controller according to claim 9, wherein
the packet issuer further issues a third packet including the identification information on the first chip and designation of a zero size; and
the transmitter further transmits the third packet to the first bus.

12. The controller according to claim 9, wherein
the packet issuer further issues a fourth packet including designation of all chips and the designation of the first size; and
the transmitter further transmits the fourth packet to the first bus.

13. The controller according to claim 9, wherein
the packet issuer further issues a fifth packet including the identification information on the first chip and designation of assignment for transfer completion notification of a first signal line; and
the transmitter further transmits the fifth packet to the first bus.

14. The controller according to claim 9, wherein
the packet issuer further issues a seventh packet including the identification information on the first chip and an instruction to set the first size in a feature register; and
the transmitter transmits the seventh packet to the first bus.

15. A chip comprising:
a receiver that receives a first packet including identification information on the chip and designation of a first size via a first bus; and
a transmitter that transmits first data of the first size to a second bus in response to the first packet being received by the receiver.

16. The chip according to claim 15, wherein
the receiver receives a second packet including the identification information on the chip and an instruction to finish transfer via the first bus; and
the transmitter terminates midway transmission of data of the first size to the second bus in response to the first packet being received by the receiver during the transmission of the data of the first size.

17. The chip according to claim 15, wherein
the receiver receives a third packet including the identification information on the chip and designation of a zero size via the first bus; and
the transmitter finishes continuous data transmission of the first size on the second bus in response to the third packet being received by the receiver.

18. The chip according to claim 15, wherein
the receiver receives a fourth packet including designation of all chips and the designation of the first size via the first bus; and
the transmitter transmits the first data of the first size to the second bus in response to the fourth packet being received by the receiver.

19. The chip according to claim 15, wherein
the receiver receives a fifth packet including identification information on the chip itself and designation of assignment for transfer completion notification of a first signal line via the first bus; and
a level of the first signal line transitions to a level indicating the transfer completion notification after the transmission of the first data by the transmitter is completed in response to the fifth packet being received by the receiver.

20. The chip according to claim 15, wherein
the receiver receives a seventh packet including identification information on the chip itself and an instruction to set the first size in a feature register via the first bus; and
the transmitter transmits third data of the first size to the second bus in response to the seventh packet being received by the receiver.
